(19) United States
(12) Patent Application Publication
(10) Pub. No.: US 2005/0177718 A1
(43) Pub. Date: Aug. 11, 2005

(54) Systems and methods for video transport service

(76) Inventor: Lou Chiorazzi, Nutley, NJ (US)

Correspondence Address: MORRISON & FOERSTER LLP, 1650 TYSONS BOULEVARD, SUITE 300, MCLEAN, VA, 22102, US

(21) Appl. No.: 11/034,200

(22) Filed: Jan. 13, 2005

Related U.S. Application Data
(60) Provisional application No. 60/540,009, filed on Jan. 30, 2004.
(60) Provisional application No. 60/535,812, filed on Jan. 13, 2004.

(51) Int. Cl. H04L 9/00

(52) U.S. Cl. 713/160

(57) ABSTRACT

The invention relates to systems and methods for traversing a firewall with real-time audio, video or data communication over a packet-based network. The video transport service solution of the invention provides a secure method of traversing multimedia streams through a firewall or network address translation that does not compromise firewall security while allowing transparent access to private endpoints. The systems and methods of the invention also enable packet-based video formats such as H.323 to traverse standard firewall and NAT devices without the firewall needing to support the H.323 protocol.

### REFERENCE TO RELATED APPLICATIONS

This application claims priority to U.S. Provisional Application No. 60/535,812 entitled “GlowPoint Video Transport Service (VTS) Technical Service Description,” and U.S. Provisional Application No. 60/540,009 entitled “Simplified Gateway Dialing (Intelligent Routing),” the entirety of which are both hereby incorporated by reference.

### FIELD OF INVENTION

This invention relates to systems and methods for traversing a firewall with video over Internet protocol (IP) communications. The invention enables extension of video conferencing services into a private IP network so that endpoints within the private network can be accessed through the use of standard E. 164 aliases or other public addresses.

### BACKGROUND

Most corporate enterprises utilize a firewall on the production data network in order to provide a secure barrier that protects the private network from unauthorized traffic on the public Internet. The firewall performs this function by opening ports to the local network only for certain types of packets. Ports are usually opened based on IP addresses and protocol types. Some firewalls also perform network address translation (NAT) or network address port translation (NAPT) which result in either the IP address or the port being translated in such a way that it is different on the public and private sides of the firewall. In NAT and NAPT systems, a table can be maintained by the firewall to keep track of the translations. While these firewall techniques can provide protection for many data applications, firewalls can also create problems for IP-based multimedia applications.

Many IP videoconferencing devices are built on the H.323 standard for multimedia communication over IP. The H.323 standard calls for the use of static ports for gatekeeper registration (RAS port 1719) and call signaling (Q.931 port 1720). Additionally, the standard calls for the use of random dynamically negotiated ports for call parameter exchange (H.245) and the video and audio streams (RTP). These dynamic ports may range from ports 1024-65535. The use of dynamic port assignments causes a conflict between H.323 videoconferencing applications and firewalls because operation through the dynamic ports would require all ports in that dynamic range to be open through a firewall. This would compromise the ability to secure a private intranet and impair the effectiveness of a firewall.

Thus, there is a need for a solution that allows videoconferencing applications to traverse a firewall without compromising the security of the private network while still allowing private endpoints to be located though public E.164 aliases.

### SUMMARY OF THE INVENTION

Broadly described herein are systems and methods for traversing a firewall with video over IP communications so that private network endpoints are fully accessible on a wide-area videoconferencing network.

In one embodiment, a method for traversing a firewall with real-time communications in a packet-based network includes transmitting a packet to a transport client from a communications client wherein the packet comprises a private IP address representing the communications client and wherein the transport client and communications client are both located in a private network, receiving the transmitted packet at a transport server from the transport client and wherein the transport client is located outside of the private network, storing in the transmitted packet an alias representing an address accessible from outside the private network, and transmitting the packet to a wide-area communications network.

In another embodiment, a system for traversing a firewall with real-time communications in a packet-based network includes a communications client for transmitting a packet to a transport client and wherein the packet comprises a private IP address representing the communications client and wherein the transport client and communications client are both located in a private network, a transport server for receiving the transmitted packet from the transport client and wherein the transport client is located outside of the private network, and a wide-area communications network configured to receive the transmitted packet, wherein the transmitted packet comprises an alias representing an address accessible from outside the private network.

### BRIEF DESCRIPTION OF THE DRAWINGS

The invention may be better understood by reference to the Detailed Description of the Invention when taken together with the attached drawings, wherein:

FIG. 1 shows an exemplary network configuration using a video transport service client behind a firewall, and

FIG. 2 shows an exemplary network configuration using a video transport service client and an enterprise gatekeeper behind a firewall.

### DETAILED DESCRIPTION OF THE INVENTION

The present invention relates to systems and methods for traversing a firewall with real-time audio, video or data communication over a packet-based network. The video transport service (VTS) solution of the invention provides for a secure method of traversing multimedia streams through a firewall or NAT that does not compromise firewall security. The systems and methods of the invention also enable packet-based video formats such as H.323 to traverse standard firewall and NAT devices without the firewall needing to support the H.323 protocol. One skilled in the art will recognize that while reference is made to the H.323 protocol, the systems and methods of the invention could be applied to other protocols with little modification.

In one embodiment, firewall traversal is accomplished through the use of a “hiding proxy” which hides the network details of the endpoint devices for which it is acting as a proxy. By using this technique, videoconference systems residing within a private enterprise can securely register and connect to a wide-area videoconferencing network (WAVN). Private endpoints are thereby given access and use of the wide-area videoconferencing network services such as a dialing plan, billing services, gateway services, or operator services, without compromising security.

### Network Components

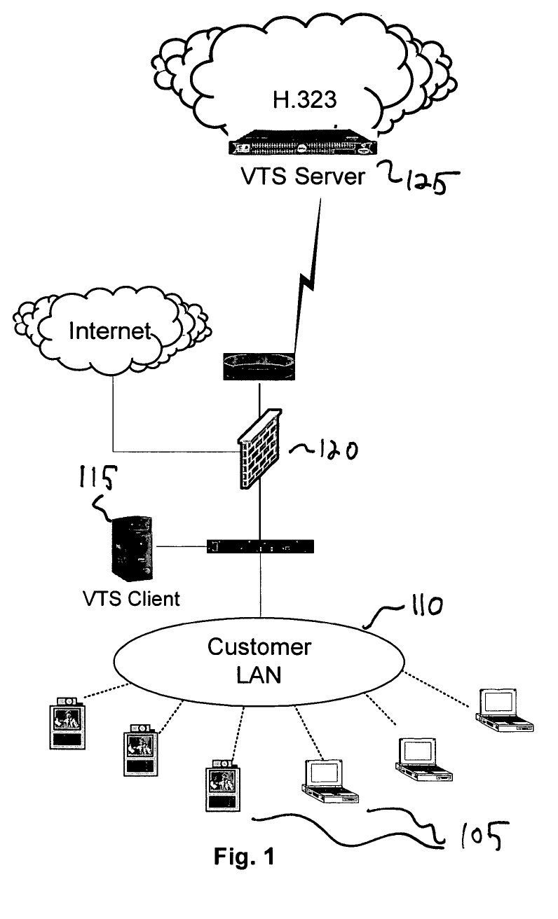

In some embodiments, the VTS can include a VTS client and a VTS service node. The VTS can be utilized with a client-server architecture in conjunction with a WAVN gatekeeper infrastructure. One exemplary embodiment is shown in FIG. 1. As shown in FIG. 1, the VTS server (125) can reside in a WAVN POP and neighbor with a WAVN gatekeeper while the VTS client (115) can be deployed in private network premises behind a firewall (120).

To configure operation of the VTS, endpoints (105) within a private LAN (110) can be configured with the VTS client (115) as their gatekeeper. According to one embodiment, a multimedia virtual tunnel can be established between the VTS client (115) and VTS server (125) via two proprietary ports through the firewall. In some embodiments, ports 2776 and 2777 may be used. Additional ports or other ports could be used in some embodiments.

Once the network is configured as described above, remote access service (RAS) messages can be transmitted from a videoconference terminal or endpoint (105) through the tunnel directly to a WAVN gatekeeper where it can be registered with a WAVN video number. The video number can be a unique H.323 E.164 alias. The registered endpoint is then able to send and receive video calls securely through the private network and the public network via a WAVN.

In the context of a WAVN, it may be desirable to access an endpoint on a private network through the use of a publicly known E.164 alias or direct inward dial (DID) phone number. The invention can render private endpoints accessible on the WAVN so that they are transparently accessible as if they were not behind a firewall.

To access private endpoints in this manner, the invention can parse and match call detail records that come from the same IP address.

If firewall traversal is performed through the use of a simple proxy alone without the present invention, all private endpoints would appear to be a single customer with a single IP address to a caller outside of the private network. The systems and methods of the invention can be configured to parse unique customers from a single IP address by examining call detail information and matching E.164 address associations to a WAVN LDAP database. This functionality allows association back to a unique customer record for billing, usage statistics and other purposes.

Additionally, call detail records can be tracked and billed through a WAVN billing system for each video system on the private network that is registered to the VTS client. A user can also take advantage of all WAVN services as described previously. Because calls generated from the private network will include E.164 alias information, call detail records (CDRs) can include billing information associated with one or more individual endpoints on a private network.

### VTS Client

The VTS client of the invention can function as a proxy for real-time communications between the private or enterprise site and one or more remote devices. The VTS client can create connections to a VTS server using network address translation traversal methods to create and maintain the connections required to support calls. A single tunneled TCP connection can be used to provide all call signaling requirements as well as coordination of media connections. In some embodiments, UDP connections can be created to relay media. In still further embodiments, connections can be created from the client to the server so that the firewall is not required to allow inbound connections. A control tunnel can be used to coordinate the creation of media connections and associate them with particular calls. The VTS client can be configured to store address information for directing communications to the VTS server.

### VTS Server

When an H.323 device sends a call setup request, the protocol can contain the device's address. The VTS server can amend the protocol to substitute its own address such that it appears to be the originating device. The VTS server can maintain a record of all the devices for which it is providing a proxy such that responses can be routed successfully back to the relevant devices.

Similarly, when a device sends a registration signal through the VTS server, the server can amend the registration so that all calls intended for the device are directed to the VTS server for forwarding. These protocols modifications can be used to maintain the anonymity of devices and are transparent to those devices.

### Deployment

Two embodiments for VTS deployment at a customer site are described in more detail below. In some embodiments, portions of proxy service of the VTS client and VTS server can be provided by a Ridgeway (TM) IPFreedom system.

In one embodiment is shown in FIG. 1. According to this embodiment, a VTS can be integrated into a customer's existing LAN (110) that allows H.323 videoconferencing traffic to traverse through an existing firewall/NAT device (120) onto the WAVN. The VTS Client (115) can be installed behind a firewall (120). As a non-limiting example, the firewall (120) can have TCP port 2776 and UDP ports 2776 & 2777 open to allow one or more of the clients (105) to create a virtual tunnel with the VTS Server (125). Non-H.323 videoconferencing traffic such as PC applications would traverse through the firewall/NAT device onto the public Internet without VTS involvement.

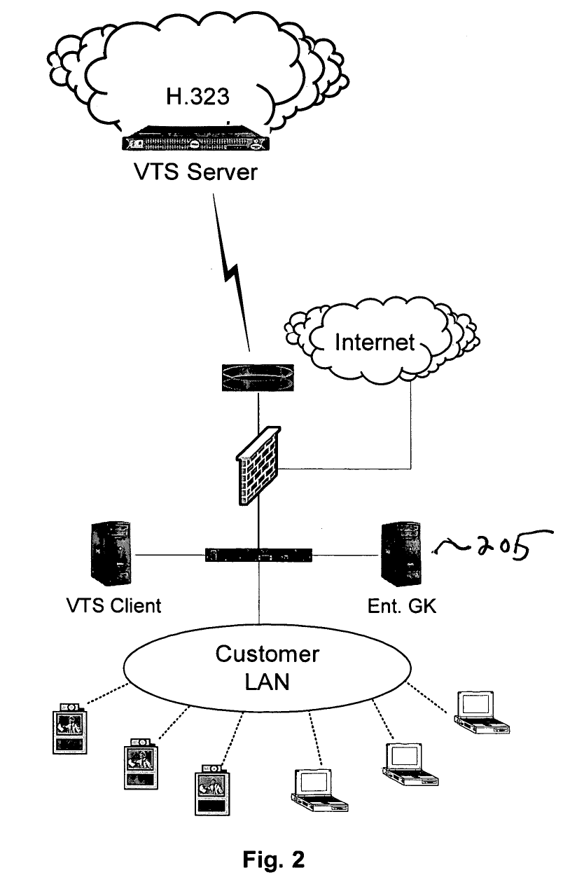

In another embodiment shown in FIG. 2, the VTS integration also includes an enterprise gatekeeper (205). With an enterprise gatekeeper (205) added, the customer can have their own dialing plan to make calls within its own zone. A benefit of having an enterprise gatekeeper is having the ability to make videoconferencing calls within the customer's LAN when the SDSL/T1circuit to the GP termination router goes down.

### Management and Monitoring

The VTS can be configured to support SNMP based management for all VTS servers and can interoperate with existing WAVN network management tools. One or more of the following management capabilities may also be provided: HTTP console, SNMP traps, add, modify and delete accounts, ability to start or stop services remotely, CPU utilization, memory utilization, disk space utilization, physical server components health, and relevant H.323 video conferencing status, errors and alerts.

One skilled in the art will recognize that the network architecture described above can be modified to include additional components or to function without one or more of the components illustrated. One skilled in the art will also realize that while systems and methods described above with reference to video transport services, the systems and methods could be readily adapted to a wide variety of applications for traversing a firewall while maintaining transparent accessibility.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A method for traversing a firewall with real-time communications in a packet-based network comprising:
transmitting a packet to a transport client from a communications client wherein the packet comprises a private IP address representing the communications client and wherein the transport client and communications client are both located in a private network,
receiving the transmitted packet at a transport server from the transport client and wherein the transport client is located outside of the private network,
storing in the transmitted packet an alias representing an address accessible from outside the private network, and
transmitting the packet to a wide-area communications network.

2. A system for traversing a firewall with real-time communications in a packet-based network comprising:
a communications client for transmitting a packet to a transport client and wherein the packet comprises a private IP address representing the communications client and wherein the transport client and communications client are both located in a private network,
a transport server for receiving the transmitted packet from the transport client and wherein the transport client is located outside of the private network, and
a wide-area communications network configured to receive the transmitted packet,
wherein the transmitted packet comprises an alias representing an address accessible from outside the private network.
